(19) United States
(12) Patent Application Publication
(10) Pub. No.: US 2016/0209367 A1
(43) Pub. Date: Jul. 21, 2016

(54) Apparatus Made by Combining a Quartz Tuning Fork and a Microfluidic Channel for Low Dose Detection of Specific Specimens in a Liquid or Gas Media

(71) Applicant: Mehdi M. Yazdanpanah, Louisville, KY (US)

(72) Inventor: Mehdi M. Yazdanpanah, Louisville, KY (US)

(21) Appl. No.: 14/597,403

(22) Filed: Jan. 15, 2015

(51) Int. Cl. G01N 29/02

(52) U.S. Cl. CPC G01N 29/022; G01N 2291/0427; G01N 2291/021; G01N 2291/022

(57) ABSTRACT

Embodiments of present invention provide apparatus that can measure very low dose of a specific specimen (such as biomarkers, protein) in a liquid or gas media. The apparatus is made of a microfluidic channel in combination by a tuning fork. The tuning fork is located outside the micro channel, but there are fibers that are attached to the end of one of the fork prongs and The liquid or gas channel is to bring a small quantity of the liquid or gas of interest in contact with micro fibers that are connected from one side to the tuning fork and are located inside the channel from the other side. The fibers are coated with specific coating and are receptors for the molecule of interest.

### STATEMENT OF GOVERNMENT INTEREST

This invention was made with Government support under Grant # IIP-1059286 from National Science Foundation. The government has certain rights in the invention.

### BACKGROUND OF THE INVENTION

Developing reliable early bio-marker diagnostics by assaying a bodily fluid through minimally non-invasive procedures (e.g. blood test, Urine test) is of high importance and can impact the quality of life for millions of people. Existing techniques include Enzyme-linked Immunosorbent Assay (ELISA), oligonucleotide (DNA or RNA) hybridization capture, PCR (polymerase chain reaction) or any number of emerging fluorescence-based techniques. In general, these techniques fall short for use in widespread population screening applications due to i) a lack of sensitivity required for early diagnostics, ii) the requirement of extensive sample preparation, or iii) high cost. Taken together, these three issues limit existing techniques and indicate that more work to develop an inexpensive early diagnostic is required.

The key to early diagnosis of a complex disease is to measure very small difference between normal and abnormal (either higher or lower) concentrations of disease biomarkers in bodily fluids. For this reason, new ultra-sensitive test methodologies are being developed to detect highly disease-specific biomarkers for various diseases such as diabetes, cancer osteoporosis, arthritic conditions and cardiac disease.

The inventors has conducted a study to demonstrate the detection of a very low concentration of targeted biomarkers from mass sensing experiments using an ultrasensitive quartz tuning fork with an attached functional gold rod. A tuning fork is a crystal oscillator with an electronic oscillator circuit that uses the mechanical resonance of a vibrating crystal of piezoelectric material to create an electrical signal with a very precise frequency. The present invention is called tuning fork combined with microfluidic channel (TFCMC).

The TFCMC is a disposable chip capable of detecting low concentration levels of multiple specimens (e.g. biomarkers, DNA, protein, etc.) in bodily fluid or a gas media.

The TFCMC comprises a microfluidic chamber that has a liquid or gas injection entrance and drainage. The entrance and the injection are connected together by a narrow channel. This embodiment also comprises a rod that is located inside the narrow channel. The rod has a functionalized coating (i.e. antibody). These specific coatings on the rod surface have specific predefined sites that only the specimen of interest from the solution can attach to them. For different specimens, different functionalized coating is required to capture the specimens of interest. Upon attachment of the specimen of interest to the rod, they add mass to the rod that can be detected by the tuning fork by monitoring the resonance frequency and vibration amplitude of the tuning fork.

### SUMMARY OF THE INVENTION

In one embodiment of the present invention, a sensing platform is invented by combining a quartz tuning fork, with a microfluidic device to detect very low dose of specific specimen in a liquid or gas medium. The Tuning fork combined with micro channel (TFCMC) has an electronic oscillator circuit that uses the mechanical resonance of the vibrating crystal to create an electrical signal. There is a rod that is attached to a fork prong from one side and the free end is located in the micro channel. The rod is coated and functionalized with a layer of specific molecules to be specific for a specimen of interest in the liquid or gas medium.

### BRIEF DESCRIPTION OF THE DRAWINGS

FIG. 1 is a schematic of the TFCMC device.

FIG. 2A is a schematic of the bottom view of the tuning fork as a micro rad is attached to one prong of the fork.

FIG. 2B is a schematic of the side view of the tuning fork with attached rod.

FIG. 3A is schematic of the close up view of channel that is narrowed near where the rod is located.

FIG. 3B is a schematic of the close up view of the rod with functionalized molecules inside the channel as the liquid or gas containing the specimen of interest is injected into the channels.

FIG. 4A is a schematic of the close up view of plurality of rods with functionalized molecules.

FIG. 4B is a schematic of the close up view of plurality of rods with functionalized molecules located inside the channel.

FIG. 5 is a schematic of the TFCMC device with vacuum capped as the fork and the channel are under the vacuum, before liquid or gas injection and after liquid or gas injection.

FIG. 6A is a schematic of the TFCMC as a liquid or gas is injected into the channel.

FIG. 6B is a schematic of the TFCMC as a liquid or gas is extracted of the channel.

FIG. 7 is a schematic of the TFCMC as it is connected to a vacuum pump to be vacuumed.

FIG. 8 is a schematic of the TFCMC with multiple channel that each a tuning fork and each tuning fork is connected with a different rod with different coating.

FIG. 9 is a schematic of the TFCMC with arbitrary shape of the can for the tuning fork.

FIG. 10 is electronic diagram of the tuning fork controller system that monitors the changes in the vibration amplitude and frequency of the tuning fork.

### DETAILED DESCRIPTION OF THE PREFERRED EMBODIMENTS

One embodiment of the present invention, TFCMC can measure very low dose of any specific specimen (e.g. antigen, DNA, any type of molecule, or nano and micro particle) in a liquid or gas medium. TFCMC is a device that is made from the combination of a quartz tuning fork and a microfluidic channel. The Tuning fork has an electronic oscillator circuit that uses the mechanical resonance of the vibrating crystal to create an electrical signal. Change in the environment can cause a shift in tuning fork self-oscillation frequency, vibration amplitude, and other parameters of the tuning fork crystal that can be monitored by electronic.

The electronics in the TFCMC consist of 3 circuit blocks. One is a self-oscillation block which forms an electrical loop together with the preamplifier connected to the fork to enable a self-oscillation of a quartz tuning fork at its resonance frequency with constant amplitude. The second block is a frequency measurement unit including a Phase-Locked Loop (PLL) circuit. The third block is a high resolution volt with a lab-view software that precisely monitor Phase, frequency, and amplitude of vibration of the fork in a real time during the entire device operation.

In one embodiment of the present invention, a rod is connected to one of the prongs of the tuning fork (TF). The rod can be coated and become functionalized with special coating in such a way that only specific specimen in a liquid or gas environment, permanently bond to the surface of the rods when then become in contact with the rod and the rest of the specimen in the liquid or gas medium do not permanently bond to the rod or if they attach to the rod, they will be separated by rinsing water into the channel.

In one embodiment of the present invention, for each specimen as long as there is a molecule (called receptor) that only bonds to such specimen, by coating the rod with specific receptor to functionalize the rods, a TFCMC detector can be built for that specific specimen.

In one embodiment of the present invention, multiple rods with smaller diameters can be attached to one of the prongs to enhance the active surface for detection and enhance the chance of attachment of the specimen to the rod.

In one embodiment of the present invention, prior to attachment of the rod to the fork, the tuning fork is coated with a conformal layer of insulated material (e.g. Parylene) to protect the device against the liquid spill from the channel onto the tuning fork electrodes.

Tuning forks are known for being extremely sensitive to added mass or external force and are widely used for mass sensing based measurements in variety of applications. However, due to the nature of any vibrating device, they have poor performance in liquid medium as well as in high pressure gas. To address this issue in one embodiment of the present invention, the TFCMC is specially designed that the tuning fork is always out of liquid and only a portion of the rod that is attached to one of the fork's prong is inside the liquid and is used as capturing site to capture the specimen of interest. As the specimen are attached to the rod, the frequency of the TF, which is monitored by the electronic circuit, changes, that later can be related to the added mass.

Quartz tuning forks are much more sensitive in vacuum than in air. To benefits from this property, in one embodiment of the present invention, the channel and the tuning fork attached to the channel can be vacuumed on enhance the sensitivity of the tuning fork. Of course during the liquid or gas injection, it will be impossible to vacuum the chamber. However before and after the liquid or gas injection, the device will be under the vacuum and the TF electrical signal (i.e. Phase, Frequency, and Amplitude of vibration) will be recorded. From the comparison between the electrical signal before and after the liquid or gas injection, the additional mass to the fork can be measured and can be related to the concentration of the specific specimen in liquid or gas medium.

In one embodiment of the present invention, the electrical signal of the TFCMC is monitored during the entire process, including prior to the liquid or gas injection when the device is under the vacuum, when the vacuum is broken, during the time that the liquid or gas is being injected, during the time that the chamber is rinsed with water to remove the non-specific bonding between unwanted specimen and the rod surface, and after the TFCMC is vacuumed again. The entire spectrum is recorded and is compared against a gold standard database (as explained in the next paragraph) for different specimen with known concentrations to accurately calculate the concentration of the unknown solution.

In one embodiment of the present invention, a standard database is developed for each specimen of interest with known concentration in a liquid or gas medium. The database is included of several electrical signals of the TFCMC for the entire process (prior to vacuum break, during the injection, after the device is vacuumed). From the comparison between the electrical signals of the known concentration with the one from unknown concentration one can measure the concentration of the unknown solution.

In one embodiment of the present invention, the injection process is uniform and a liquid or gas injection mechanism with precise liquid or gas delivery amount is designed to inject the liquid or gas medium into the device consistently for all the measurements.

In one embodiment of the present invention, the real time monitoring of the TF allows for real time monitoring of the change in the concentration of the specimen in the liquid or gas environment. Such monitoring can be used for real time monitoring of effect of a drug or a chemical in increase of decrease in concentration of a specific specimen in a liquid or gas medium.

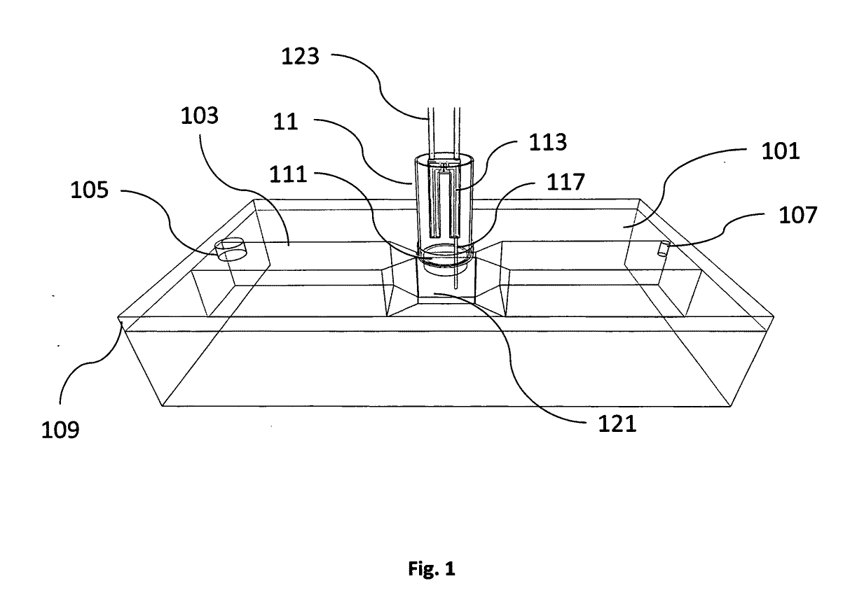

FIG. 1 shows a schematic of an embodiment of the TFCMC device (101). The TFCMC (101) includes a channel (103) that has an entrance (105) and a drain or vent (107). The channel is covered with a cover (109). The cover (109) has a hole (111) and a tuning fork (113) that is inside a cylindrical shape can (115) is connected to the hole (111) from the top of the hole (111). The tuning fork is not inside the channel, but there is a rad (117) that is connected from one side to a prong of the tuning fork (113) and the other side of the rod (117) is located inside the channel (103). In this example, the channel (103) is narrower in the middle (121) and the width of the narrower area of the channel (121) is only 2 to 3 fold larger than the diameter of the rod (117). The tuning fork (113) has two electrical contacts (123) for signal readout from the tuning fork (113) that is connected to electrical circuit (not shown here).

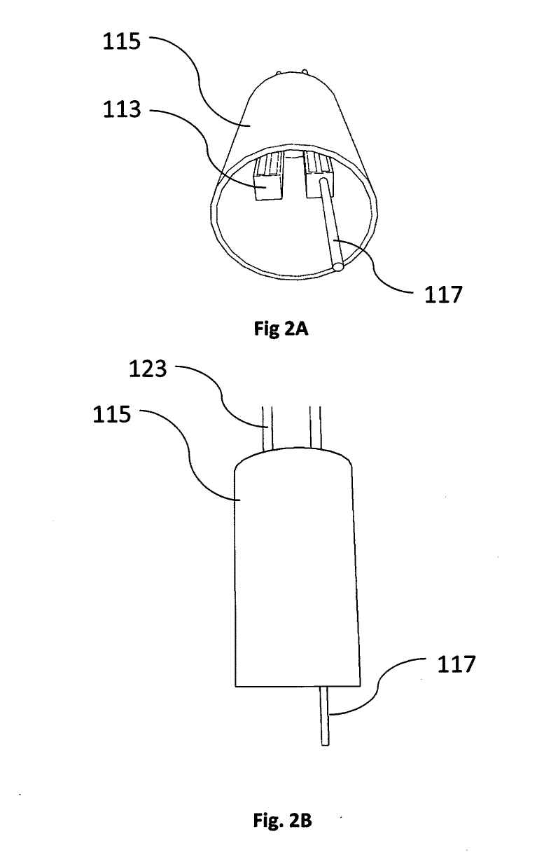

FIG. 2A shows a schematic of the bottom close up view of the tuning fork (113), inside the can (115) and the rod (117) is attached to the fork prong. The attachment is done using available nonconductive glue (not shown here) under a magnified lens. FIG. 2A, shows the side view of the can (115) with the rod (117) that stick out of the can while one side of the rod is attached to the tuning fork (113) not shown in FIG. 2B.

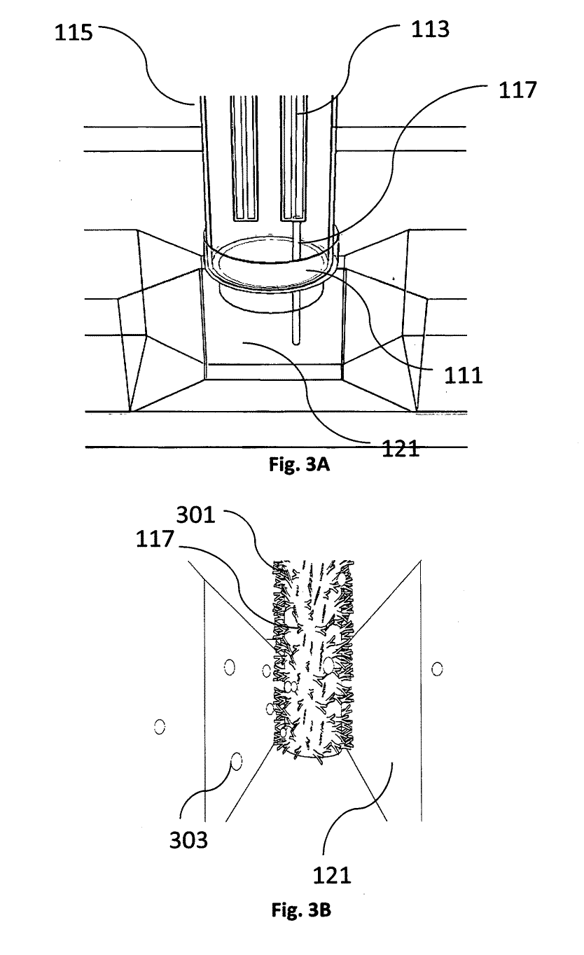

FIG.3A shows a close up view of the narrower area of the channel (121) where there is an opening (111) and the tuning fork can (115) fits into the opening (111). The fork is located outside the channel and the rod (117) is inside the channel.

FIG. 3B shows a schematic of the rod (117) that has been coated with a functionalized layer (301) and is located inside the narrow part of the channel (121). Inside the channel there is a liquid or gas medium (not shown) that consists of the specimen of interest (303). The coating (301) is designed in such a way that only the specimen of interest (303) can be permanently attached to the coating. In case if there are other specimens in the liquid or gas, they will either not attach to the coating (301) or if they do attach, the bonding will be temporarily and they can be washed off if the device is rinsed with pure water.

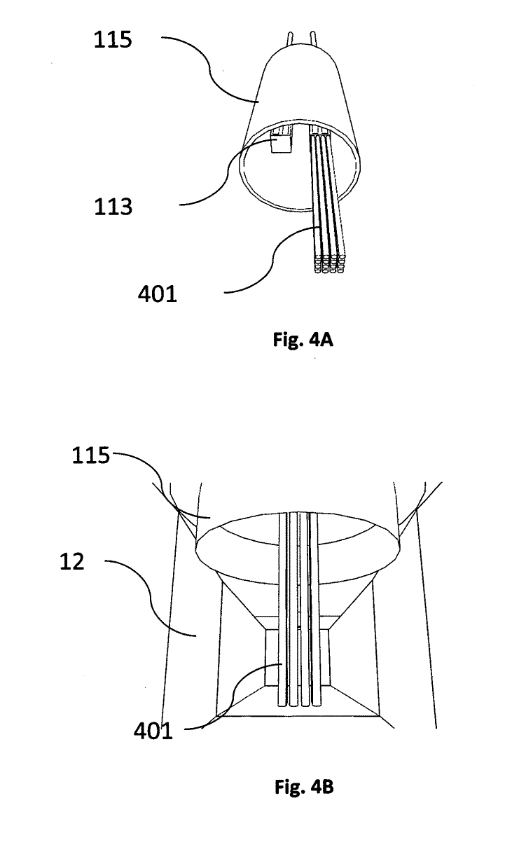

FIG. 4A shows schematic of a plurality of functionalized rods (401) that are attached to one of the tuning for prong (113). In this example, pluralities of functionalized rods have larger surface area that enhances the chance of capturing the specimen of interest.

FIG. 4B shows a schematic of the inside channel (121) as plurality of functionalized rods (401) are attached to a fork prong and are located inside the channel (121) and are attached to one of the prongs of the tuning fork (113). In addition in this example the plurality of rods (401) causes a turbulence in the liquid or gas flow and enhances the chance of colliding the specimen of interest (301) with one of the rods (401) and attaching the specimen (301) to the rod (401).

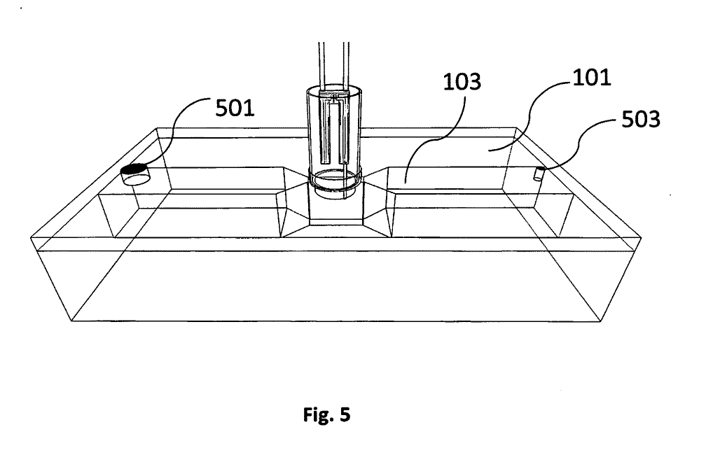

FIG. 5 shows a schematic of the TFCMC (101) that has been sealed by two sealing caps (501) and (503). The sealing caps (501) and (503) can keep the TFCMC (101) under the vacuum before the liquid or gas medium is injected into the channel (103) and after the liquid or gas medium is being retracted from the channel (103). The can (115) is also attached and fixed into the opening (111) with special glue that keep the entire channels (103) and (121) under the vacuum with no air leak.

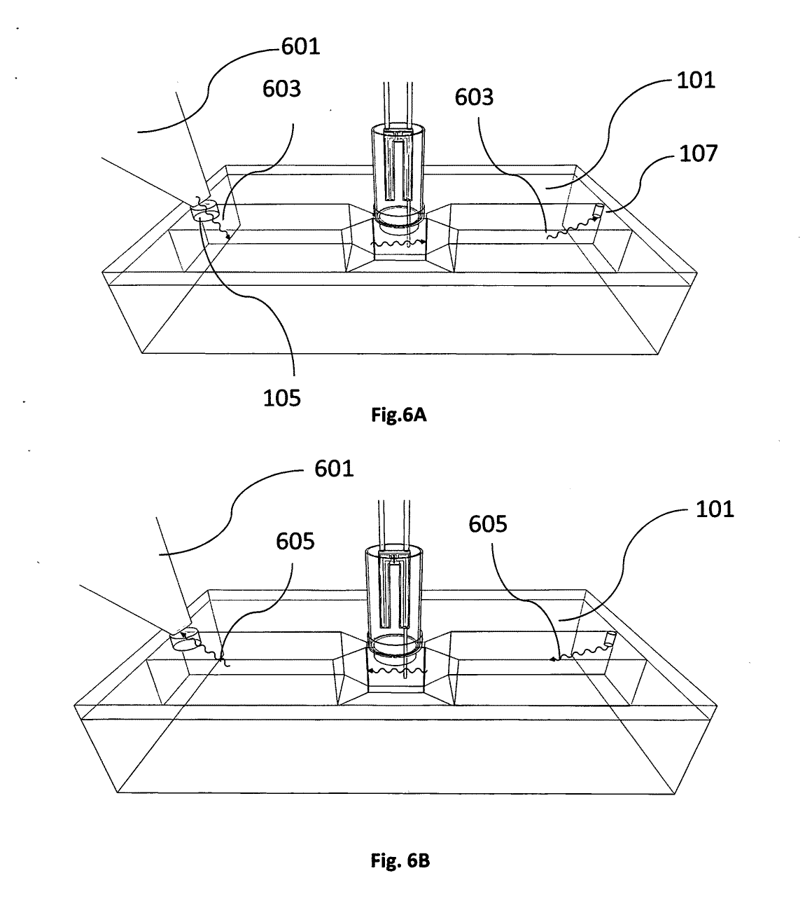

FIG. 6A shows a schematic of the TFCMC (101) as a liquid or gas injection tool (601) such as a syringe is used to inject the liquid or gas into the channel (103) via the entrance (105). During the liquid or gas injection, the air is exhausted out of the channel (103) from the vent (107). In this example the direction of liquid or gas flow is shown by arrow (603).

FIG. 6B shows a schematic of the TFCMC (101) as the liquid or gas injection tool (601) is used to extract out the liquid and gas from the channel (103). The direction of the liquid or gas flow is shown by (605). In this example, the chance of colliding the specimen with the rod (121) is increased by a factor of 2 when the liquid or gas is injected and then extracted out of the channel through the entrance (105).

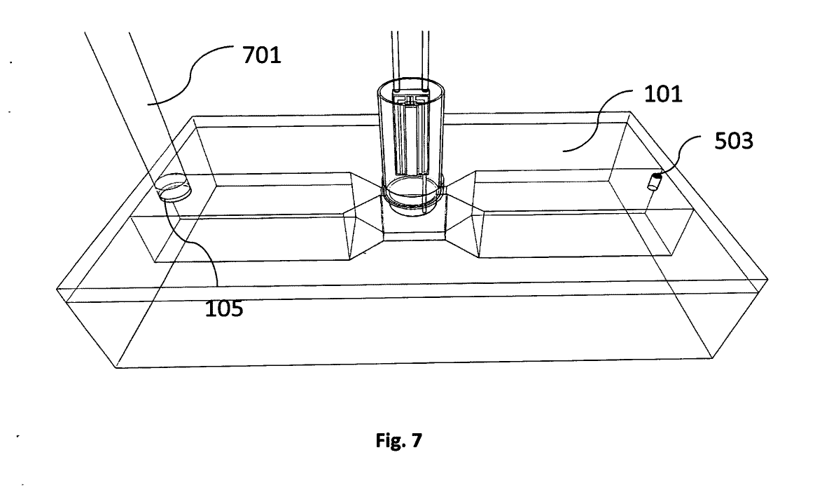

FIG. 7 shows schematic of TFCMC (101) as the device is being vacuumed by connecting to a vacuum pipe (701) that is connected to a vacuum pump (not shown here) to the entrance (105) to extract the air and remaining liquid or gas from the channel and reduce the pressure in the channel as well as around the tuning fork. By vacuuming the chamber, the sensitivity of the fork increases.

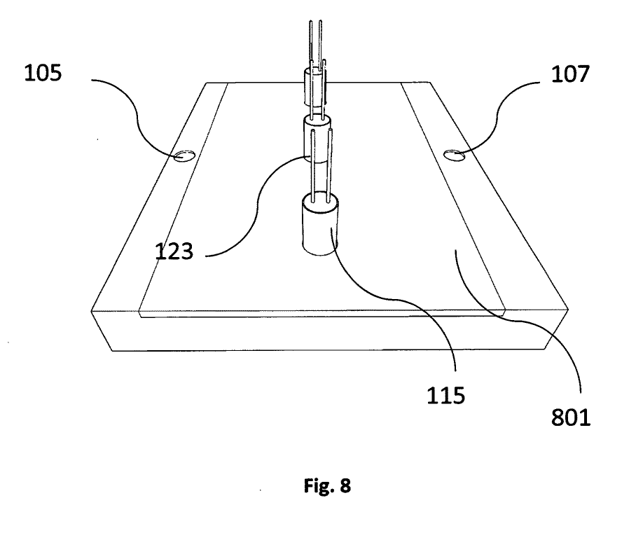

FIG. 8 shows another example of the TFCMC device (801) that has plurality of channels (103) and plurality of tuning forks (113) are attached to the channel for multiple read out. In this example, the rods (117) that are attached to each fork are being functionalized with different coating and therefore each rod is able to only capture one type of specific specimen (303) in the liquid or gas medium. In this example of multichannel TFCMC (801), the device is capable of measuring the concentration of multiple specimens (303) in a liquid or gas medium.

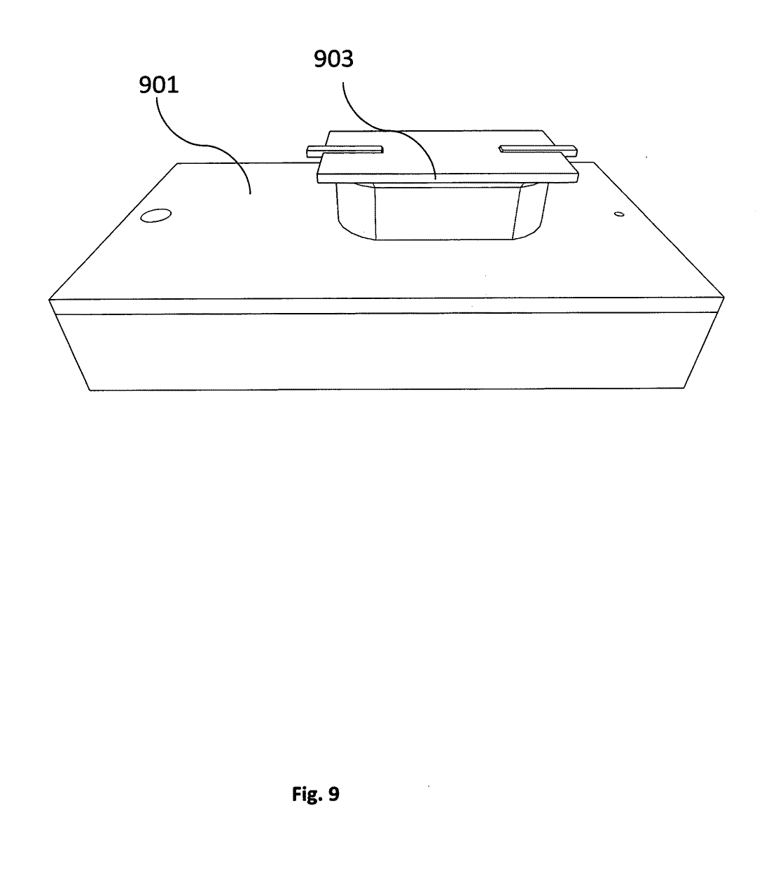

FIG. 9 is a schematic of another example of the TFCMC device (901) where the shape of the tuning fork can (903) is arbitrary and different than cylindrical shape can (115) shown in FIG. 1. In this example the rod (117) can be attached to the fork (113) perpendicular to the fork prong.

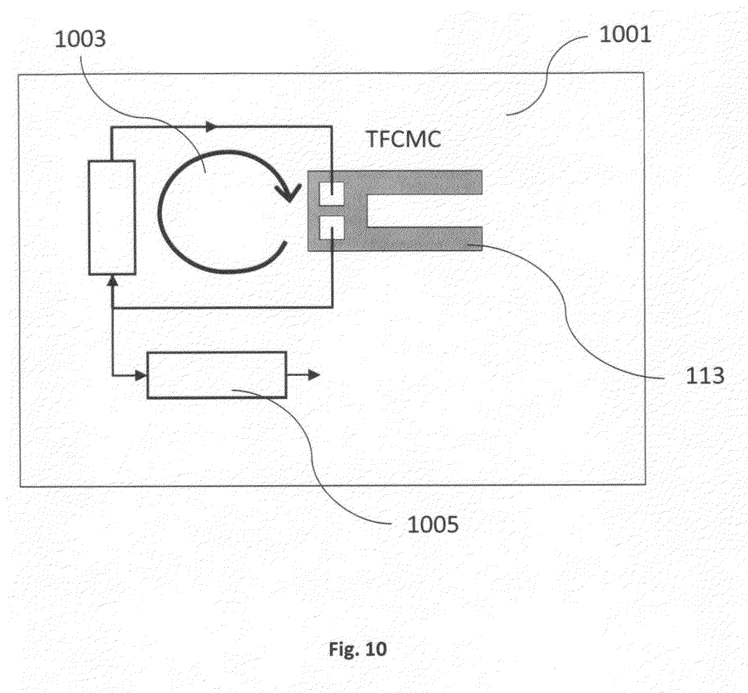

FIG. 10 is schematic of the electronic circuit that reads the changes in frequency and amplitude of the tuning fork under different conditions. The circuit (1001) that includes a self-oscillation circuit (1003) connected to the tuning fork (113) and oscillates the tuning fork at its resonance frequency. As the tuning fork is influenced by the liquid or gas medium in the channel, the frequency of the fork and its amplitude is changed that is measured by a detection frequency unit (1005). The data that are mainly a DC signal are collected by a computer and saved as a function of time and later depicted in a curve.

1. A sensing device for measuring the concentration of a specific specimen in a liquid or gas medium, said device comprising:
A tuning fork and a microfluidic channel, where said the microfluidic channel is to deliver said liquid or gas medium, and said the tuning fork is used for measuring the concentration of said specific specimen in the liquid or gas medium, wherein a rod is attached to said one tuning fork prong from one end, wherein the rod surface is treated so that the surface of said rod demonstrate selective adhesion towards said specific type of said specimen in said liquid or gas medium, wherein said the tuning fork is outside the liquid or gas medium and only a portion of said rod is inside the liquid or gas.

1. The device in claim 1, where the said tuning fork stays outside the liquid or gas and a portion of said rod stays inside the liquid or gas

2. The device in claim 1, where said rod is treated so that the surface of said rod demonstrate selective adhesion towards said specific type of said specimen in said liquid or gas medium.

3. The device in claim 1, where said the rod in claim 3 is a porous rod with higher surface area.

4. The device in claim 1, where plurality of said rods are attached to said tuning fork prong.

5. The device in claim 1, where said device comprise of plurality of said micro-channels and plurality of said tuning forks, where said rod attached to each said fork is treated differently so that the surface of each said rod demonstrate selective adhesion toward said specific type of said specimen in said liquid or gas medium.

6. The device in claim 1, where said microfluidic channel and said attached tuning fork is vacuumed before and after said liquid or gas is pumped into the said microfluidic channel to enhance the sensitivity of the said tuning fork prior to and after attaching said specimen to said rod.

7. The device in claim 1, where the frequency and the amplitude of the vibration, of said tuning fork is monitored in real time, said spectrum versus time.

8. The device in claim 1, where said microfluidic channel is narrowed near said rod

9. A standard experimental procedure where the device in claim 1 is used to collect said spectrum versus time in real time of said tuning fork; as said tuning fork is in vacuum prior to liquid or gas injection to said channel, after the vacuum is broken and said microfluidic channel is filled with air, during the time that said liquid or gas medium is injected into said channel, after said liquid or gas is removed from said channel, after said the channel is vacuumed.

10. A calibration method, where device in claim 1 is utilized to collect said spectrum versus time said in claim 6 from known said liquid or gas medium with known concentration of said specimen, where the flow rate of the liquid or gas into said channel is controlled and is consistent for all said spectrum versus time measurement.

11. A database comprise of many said spectrum versus time said in claim 6 that are collected by the device in claim 1 from known said liquid or gas medium with known concentration of said specimen.

12. A monitoring mechanism that is connected to said tuning fork and read and collect said spectrum versus time of said tuning fork that includes said vibration frequency, vibration amplitude, phase shift, as a function of time with high precision.

13. A method for concentration measurement of an unknown specimen in said liquid or gas medium, where the device in claim 1 is used, the monitoring mechanism in claim 12 is used to monitor said spectrum versus time in claim 6, the standard experimental procedure in claim 9 is used, and said spectrum versus time is compared against said database in claim 11 of known said liquid or gas medium with known said specimen concentration 11 to measure the concentration of the specific specimen.

14. The device in claim 1 that can be used for real time monitoring of specific specimen in a fluidic medium
